(19) United States
(12) Patent Application Publication
(10) Pub. No.: US 2012/0016080 A1
(43) Pub. Date: Jan. 19, 2012

(54) INITIATORS FOR POLYMERIZATION OF VINYL MONOMERS BASED ON THE REACTION OF PHENOXYALUMINUM COMPLEXES WITH OXYGEN

(76) Inventors: Gary L. Jialanella, Oxford, MI (US); Peter N. Nickias, Midland, MI (US); Shaoguang Feng, Shanghai (CN); Toni Ristoski, Shelby Township, MI (US); Eric P. Wasserman, Hopewell, NJ (US)

(21) Appl. No.: 13/179,633

(22) Filed: Jul. 11, 2011

Related U.S. Application Data
(60) Provisional application No. 61/364,451, filed on Jul. 15, 2010.

(51) Int. Cl. C09D 7/14; C09J 4/02; B05D 1/26; B05D 3/04; B05D 1/02; B05D 1/28; C09K 3/00; C09D 4/02

(52) U.S. Cl. 524/853; 252/182.14; 526/186; 427/331

(57) ABSTRACT

One exemplary embodiment includes a method comprising polymerizing vinyl monomers with an initiator comprising a phenoxyaluminum alkyl compound in the presence of oxygen.

### CROSS REFERENCE STATEMENT

This application claims the benefit of U.S. Provisional Application No. 61/364,451, filed Jul. 15, 2010, which is incorporated herein by reference.

### TECHNICAL FIELD

The field to which the disclosure generally relates to includes methods of polymerizing vinyl monomers based upon the reaction of phenoxyaluminum complexes with oxygen.

### BACKGROUND

There may be instances in which one wishes to apply a tough polymer film upon a surface simply by exposure to air of a low-viscosity formulation consisting of a monomer and a latent initiator. Such coatings may be made with the intention of sealing a substrate from the elements and abrasion, hiding (painting) the substrate, or causing one substrate to adhere to another. One system which has been shown to work for this type of application consists of mixtures of boron alkyl compound, optionally protected by Lewis base (e.g., amine), dissolved in one or more vinyl monomers (e.g., methyl methacrylate). Rapid polymerization of the monomer occurs upon the addition of oxygen to the mixture. However, boron alkyls are expensive.

### SUMMARY OF EXEMPLARY EMBODIMENTS OF THE INVENTION

One exemplary embodiment includes a method comprising polymerizing vinyl monomers with an initiator comprising a phenoxyaluminum alkyl compound in the presence of oxygen.

Another exemplary embodiment of the invention includes a method comprising (a) providing a hindered phenol in a dry hydrocarbon solvent and adding a trialkylaluminum compound thereto to provide a solution; (b) mixing one or more activated vinyl monomers to provide a mixture; (c) applying the mixture to a substrate; and (d) exposing the mixture on the substrate to air to initiate the polymerization of the vinyl monomers.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### DETAILED DESCRIPTION OF EXEMPLARY EMBODIMENTS

The following description of the embodiment(s) is merely exemplary (illustrative) in nature and is in no way intended to limit the invention, its application, or uses.

Although aluminum alkyl complexes are less expensive than their boron analogs, aluminum alkyl complexes are much more reactive with oxygen and water. Direct exposure with most aluminum alkyl compounds to air generally results in a violent oxidation and hydrolysis, and thus the initiation of vinyl polymerization using such techniques is difficult to control. Surprisingly, it has been determined that a family of aluminum complexes produced by the reaction of aluminum alkyls with hindered phenols, although less pyrophoric than aluminum alkyls themselves, are better initiators for the polymerization of vinylic monomers such as methyl methacrylate than the aluminum alkyls from which they are derived and are roughly as effective as boron alkyls. As a side benefit, the hindered phenoxide ligands may act as antioxidants to stabilize the ultimate polymer as they are released from coordination to aluminum through slow hydrolysis caused by exposure to air over extended times.

Another embodiment of the invention includes an initiator system for the polymerization of vinyl monomers such as, but not limited to, acrylates. The initiator may comprise a phenyloxyaluminum alkyl compound which initiates radical polymerization under the vinyl monomers upon exposure to oxygen. The phenyloxyaluminum alkyl compound may be present in about 0.001 to about 5 weight percent and about 10 to about 99 weight percent of vinyl monomers may be present. Such a system may be useful for the preparation of quick-curing coatings and adhesives. In one embodiment, such a system may be used as structural adhesives for automotive applications.

One embodiment includes a method of initiating the polymerization of vinyl monomers including (1) dissolving a hindered phenol in a solvent, such as but not limited to, a hydrocarbon solvent in an inert gas; (2) adding a trialkyl aluminum compound to the solution formed in (1) under inert gas; (3) adding the solution formed in (2) to a mixture of one or more active vinyl monomers under inert gas; (4) applying the mixture formed in (3) to a substrate by brushing, spraying, extruding or by another method appropriate for the end use; (5) exposing the treated surface having the mixture applied thereto from (4) to air (or oxygen) for a finite time. If desired, the method may be conducted so as to isolate the compound formed in (2) by evaporation or crystallization and thereafter adding such compound, either neat or dissolved in an appropriate solvent, to the mixture of one or more activated vinyl monomers. A specific time may need to elapse to complete the reaction of step (2). If desired, a second substrate may be applied to the treated surface before the mixture dries to form a bond between the two substrates. Optionally, additional stabilizers such as a Lewis base (e.g., a tertiary amine) may be utilized. The inclusion of a deprotecting component along with the monomers to remove the stabilizer is an option with respect to step (2). Deprotecting compounds are known to those skilled in the art, and are generally Brønsted acids of sufficient acidity to bind more strongly to the Lewis base than the aluminum compound.

In one embodiment, an alkyl aluminum reagent may be utilized in step (2) having the formula AlR₁ R₂ R₃, wherein R₁, R₂, R₃ are the same or different and are alkyl group chains including 1 to 20 carbons or hydrogen. The molar ratio of OH groups in the hindered phenol to aluminum atoms in step (2) ranges from 0.2:1 to 2.5:1.

Another embodiment of the invention includes coatings or adhesives including vesicles containing monomer/phenyloxyaluminum complex mixtures in a sufficient amount and location to provide “self-healing” properties to the coating or adhesive. The vesicles, once broken by the propagation of a crack through a coating or adhesive mixture, will release a low-viscosity fluid which will fill the crack and then rapidly cure as air diffuses into it.

The above description of embodiments of the invention is merely exemplary in nature and, thus, variations thereof are not to be regarded as a departure from the spirit and scope of the invention.

The following examples are illustrative of various embodiments of the invention.

### EXAMPLE 1

Under nitrogen, a 50 mL oven dried amber vial was charged with a magnetic stirbar and 86 mg 2,6-di-t-butyl-4-methylphenol (BHT), 3.05 g dry hexanes, and 0.344 g of a 1 mol/L solution of triethylaluminum (TEAl) in hexanes (d=0.692 g/mL). The mixture, having a BHT:Al molar ratio of 0.8, was sealed and removed from the glovebox. To the mixture was then added 0.935 g methyl methacrylate (MMA, held over molecular sieves and deaerated by nitrogen sparge). Pure oxygen (5 mL, molar ratio of O2:Al=0.41) was injected and the stirring solution held in an oil bath (T=26° C) for 2.3 h, followed by the injection of 3 mL of a deaerated solution prepared from 39 mg BHT in 10.12 g methanol. After stirring for a few minutes with this quenching solution, the volatile components of the mixture were removed by the application of vacuum and mild heat for 1 h, followed by drying in a vacuum oven at 51-53° C. overnight. The gross yield of non-volatile material was 0.450 g, and after correcting for residual BHT (7.0 wt %, determined by GC) and MMA (0.5 wt %, determined by GC), the net yield of polymer was estimated to be 0.416 g, for a MMA conversion of 45%.

### EXAMPLE 2

Under nitrogen, a 50 mL oven dried amber vial was charged with a magnetic stirbar and 181 mg BHT, 3.12 g dry hexanes, and 0.317 g of a 1 mol/L solution of triisobutylaluminum (TiBA) in hexanes (d=0.695 g/mL). The mixture, having a BHT:Al molar ratio of 1.8, was sealed and removed from the glovebox. To the mixture was then added 0.943 g MMA (held over molecular sieves and deaerated by nitrogen sparge). Pure oxygen (5 mL, molar ratio of O2:Al=0.45) was injected and the stirring solution held in an oil bath (T=26° C.) for 2.3 h, followed by the injection of 3 mL of a deaerated solution prepared from 39 mg BHT in 10.12 g methanol. After stirring for a few minutes with this quenching solution, the volatile components of the mixture were removed by the application of vacuum and mild heat for 1 h, followed by drying in a vacuum oven at 51-53° C. overnight. The gross yield of non-volatile material was 0.557 g, and after correcting for residual BHT (13.0 wt %, determined by GC) and MMA (0.1 wt %, determined by GC), the net yield of polymer was estimated to be 0.484 g, for an MMA conversion of 51%.

### Comparative Example C1

Under nitrogen, a 50 mL oven dried amber vial was charged with a magnetic stirbar, 3.11 g dry hexanes, and 0.356 g of a 1mol/L solution of triethylaluminum (TEAl) in hexanes (d=0.692 g/mL). The solution was sealed and removed from the glovebox. To the mixture was then added 0.937 g MMA (held over molecular sieves and deaerated by nitrogen sparge). Pure oxygen (5 mL, molar ratio of O2:Al=0.40) was injected and the stirring solution held in an oil bath (T=26° C.) for 2.3 h, followed by the injection of 3 mL of a deaerated solution prepared from 39 mg BHT in 10.12 g methanol. After stirring for a few minutes with this quenching solution, the volatile components of the mixture were removed by the application of vacuum and mild heat for 1 h, followed by drying in a vacuum oven at 51-53° C. overnight. The gross yield of non-volatile material was 0.179 g, and after correcting for residual MMA (0.1 wt %, determined by GC), the net yield of polymer was estimated to be 0.171 g, for an MMA conversion of 18%.

### Comparative Example C2

Under nitrogen, a 50 mL oven dried ambier vial was charged with a magnetic stirbar, 3.24 g dry hexanes and 66 mg tri-n-butylborane. The solution was sealed and removed from the glovebox. To the mixture was then added 0.929 g MMA (held over molecular sieves and deaerated by nitrogen sparge). Pure oxygen (5 mL, molar ratio of O2:B=0.57) was injected and the stirring solution held in an oil bath (T=27° C.) for 2.3 h, followed by the injection of 3 mL of a deaerated solution prepared from 123 mg BHT in 37.4 g methanol. After stirring for a few minutes with this quenching solution, the volatile components of the mixture were removed by drying in a vacuum oven at 53° C. overnight. The gross yield of non-volatile material was 0.536 g, and after correcting for residual MMA (2.4 wt %, determined by GC), the net yield of polymer was estimated to be 0.524 g, for an MMA conversion of 56%.

What is claimed is:

1. An initiator system for polymerization of vinyl monomers comprising:
a phenyloxyaluminum alkyl compound and molecular oxygen.

2. A system as set forth in claim 1 wherein the vinyl monomers comprise acrylic acid, methacrylic acid, and organic esters thereof.

3. A system as set for claim 1 wherein the phenyloxyaluminum alkyl compound is present in an amount ranging from about 0.001 to about 5 and the weight percent of vinyl monomers ranges from about 10 to about 99.

4. A method of initiating the polymerization of vinyl monomers comprising:
(1) dissolving a hindered phenol in a solvent, such as but not limited to, a hydrocarbon solvent in an inert gas;
(2) adding an alkyl aluminum reagent to the solution formed in (1) under inert gas;
(3) adding the solution formed in (2) to a mixture of one or more active vinyl monomers under inert gas;
(4) applying the mixture formed in (3) to a substrate by brushing, spraying, extruding or by another method appropriate for the end use;
(5) exposing the treated surface having the mixture applied thereto from (4) to air (or oxygen) for a finite time.

5. A method as set forth in claim 4 wherein the alkyl aluminum reagent comprises a trialkylaluminum compound.

6. A method as set forth in claim 4 wherein the alkyl aluminum reagent has the formula AlR₁ R₂ R₃, wherein R₁, R₂, R₃ are the same or different and are alkyl group chains including 1 to 20 carbons or hydrogen.

7. A method as set forth in claim 4 wherein the molar ratio of OH groups in the hindered phenol to aluminum atoms in step (2) ranges from 0.2:1 to 2.5:1.

8. A method of initiating the polymerization of vinyl monomers comprising:
(1) dissolving a hindered phenol in a solvent, such as but not limited to, a hydrocarbon solvent in an inert gas;
(2) adding an alkylaluminum reagent to the solution formed in (1) under inert gas;
(3) isolating the compound formed in (2)
(4) adding the isolated compound formed in (3) to a mixture of one or more active vinyl monomers under inert gas;
(5) applying the mixture formed in (4) to a substrate by brushing, spraying, extruding or by another method appropriate for the end use;
(6) exposing the treated surface having the mixture applied thereto from (5) to air (or oxygen) for a finite time.

9. A method as set forth in claim 8 wherein the alkyl aluminum reagent comprises a trialkylaluminum compound.

10. A method as set forth in claim 8 wherein the alkyl aluminum reagent has the formula AlR₁ R₂ R₃, wherein R₁, R₂, R₃ are the same or different and are alkyl group chains including 1 to 20 carbons or hydrogen.

11. A method as set forth in claim 8 wherein the molar ratio of OH groups in the hindered phenol to aluminum atoms in step (2) ranges from 0.2:1 to 2.5:1.

12. A product comprising:
a coating or adhesive comprising vesicles comprising monomer/phenyloxyaluminum complex mixtures in a sufficient amount and location to provide “self-healing” properties to the coating or adhesive so that the vesicles, once broken by the propagation of a crack through a coating or adhesive mixture, will release a low-viscosity fluid which will fill the crack and then rapidly cure as air diffuses into it.
